(19) United States
(12) Patent Application Publication
(10) Pub. No.: US 2014/0255566 A1
(43) Pub. Date: Sep. 11, 2014

(54) DEVICE AND METHOD FOR CONTROLLING, ANALYZING AND MANAGING PHASES OF CONVERSATION AND/OR PROCESSING OF FOOD IN A MOBILE OR FIXED CLOSED SPACE

(71) Applicant: Alessandro CUOMO, Crotone (IT)

(72) Inventor: Alessandro Cuomo, Crotone (IT)

(21) Appl. No.: 14/351,564

(22) PCT Filed: Oct. 21, 2012
(86) PCT No.: PCT/EP2012/070832

§ 371 Date: Apr. 13, 2014

(30) Foreign Application Priority Data
Oct. 20, 2011 (IT) MI2011A001902
Oct. 20, 2012 (IT) CS2012A000036

(51) Int. Cl. A23L 1/48

(52) U.S. Cl. CPC A23L 1/48
USPC 426/231; 99/486

(57) ABSTRACT

Device and method for controlling, analyzing and managing phases of conservation and/or processing of food in a mobile or fixed closed space comprising a user interface with elements for data entry, a master control unit with memory and software, a management means system of the physical parameters of the food and/or of the space in which said food itself is inserted, integrated means for controlling and measuring the pH, means for controlling physical parameters of food and/or of the space in which said food is inserted, characterized by the fact that the master unit has a software program which has in memory of one or more foods to be conserved or transformed, and for each food the succession of variations of the Physical parameters for each phase of conserving and/or processing, which has for each phase a safety interval of pH where said software manages for each value of the pH measured outside the safety interval of each phase a management program of physical parameters of food and/or the space in which said food is inserted to bring the pH value within the safety interval of pH, that said integrated means for controlling and measuring the pH is provided with a calibration system of the means for controlling and measuring the pH.

### TECHNICAL FIELD OF THE INVENTION

The present invention relates to a method and a device for the programmable controlling, analyzing and managing of the processes of conservation and/or processing of food in a mobile or fixed closed space, such as by way of non-limiting example tanks, tank trucks, warehouses , refrigerated cabinets, cabinets and rooms for seasoning, where through the management of physical parameters of the space and/or of the food products the acidity of the food is checked by measuring pH, and where the instrument for measuring pH is calibrated before and/or during the phase of conservation and/or transformation, and the pH value of the food is maintained within predetermined limits through the management of the physical parameters in one or more phases of processing and/or conservation.

### STATE OF THE ART

To process and/or to conserve food refrigerators, ovens or seasoning cabinets are used.

One of these is described in DE-A1-2725781 in which a device for transforming food products through the control and management of a sequence of physical parameters is present. Among the values that are checked is also the pH that nevertheless is not modified if it is found that is outside preset limits.

Through the measure of pH the degree of acidity of foodstuffs is measured and pH is one of the values that influences healthiness, conservation and/or processing of food products.

DE-3319528-A1 describes a process for the maturation and drying of sausages or other similar foods in which during the treatment the decrease of pH and/or the loss of weight are measured and temperature, humidity and/or flow air rate are similarly controlled. Substantially the process controls that the pH is maintained within the preset limits but it has no means to make sure that by acting on the physical parameters of the environment the pH remains within the preset limits, neither the pH meter is calibrated prior to and during each measuring operation.

GB-1037239-A discloses a cooking appliance for jams in which the pH is measured continuously.

The increase or decrease in acidity outside of a predetermined range opens a valve in order to provide, in the first case, sodium citrate or alkali, and in the second case, citric acid.

The correction of acid takes place with the addition of chemicals which vary the composition of the foodstuff.

One of the purposes of the present invention is to provide a device for conserving and/or processing, in a mobile or fixed closed space, foods that, since it has been found a pH value outside of a safety preset interval, said device is able, to bring the pH measured inside the safety preset interval (pH minimum and pH maximum), through the control and management of physical parameters and after that the pH meter was calibrated, since it is equipped with a system of calibration of the pH measuring means.

The device monitors, analyzes and manages the processing or conservation of food, taking into account its degree of acidity and affects the change rather than degradation through actions on physical parameters created by a software integrated in its memory on board and indicates if the same food may be inadvisable or dangerous for human consumption in accordance with the food safety parameters laid down or imposed by law , or programmed by the user.

The device has in its master unit a software that contains all foods that can be processed or conserved and for each food all the phases that must be performed, and for each phase of each food the allowed limits of pH, and if the measured pH is outside of these limits, the variations of the physical parameters that must be undertaken to restore pH within the limits provided for each phase.

The device, also, to accurately manage the changes of the physical parameters, has a system of calibration of the pH probes and re-parameterization software of the measuring means of pH, before, during and/or at each phase calibrates one or more pH probes through sequential immersion in two solutions at known pH and a software trace the curve of pH from 0 to 14, parameterizing and recoding the pH-metric software system.

The same instrument in the case of hyper-acidification and/or hyper-alkalinity of a foodstuff, i.e. alteration of the pH (power of hydrogen) compared to the safety limits imposed by law or set by the user and configured in the software will automatically send to a recipient, for example to the competent health authorities and/or to an appointed officer coded in the software or to a database, the identification of the owner of the fixed or mobile plant of processing and/or conserving, a printout of the report of historical data, by way of non limiting example, temperature, humidity, pH and calibration of such a graph showing the degradation curve, a photographic evidence (if possible), without the possibility that the user may affect the sending of such automated reporting.

The same device, as non-limiting example, in case of use for processing not liquid food in controlled fermentation, interacts and manages the fundamental physical factors such as: the control and analysis of pH (hydrogen power)—time—temperature—humidity—ventilation—shaking of the food—air flow—plant stops—with registration, visualization and memory of the same factors during use, to be applied on machines, systems or processing plants for food and/or refrigerated conservation.

Another main goal is to provide a method for the control and management of the conservation and/or processing of foods in a mobile or fixed closed space comprising data entry of food, sending said data to a master unit, processing data entered through a software program, control of physical parameters in each single phase, characterized by the fact that through the elaboration of data, the software program stores a safety interval of the pH of the food that must be maintained in every phase, calibrates the system of measurement of pH, verifies continuously through the measurement of the pH of the food during conservation and/or processing, if the pH is within the range of safety determined and if the pH is outside the range determined, manages the means for varying the physical parameters of the space in which is inserted the product and/or said product, so as to bring the pH within the range of safety determined.

Process management for conserving and/or processing is controlled, analyzed, stored and played back automatically by a “MASTER” electronic control with interface for the operator.

Other features will become clear from the representation given by way of non-limiting example in FIGS. 1, 2, 3 and 4.

### BRIEF DESCRIPTION OF THE FIGURES

FIG. 1 shows the constituent elements of the device object of the present invention.

FIG. 2 shows a logic diagram of the device object of the present invention.

FIG. 3 shows an embodiment of the device object of the present invention to a facility for stewing—drying—seasoning—aging.

FIG. 4 shows a graph and a printout, created and stored by the device object of the present invention.

### DESCRIPTION OF THE CONSTITUENT ELEMENTS OF THE DEVICE OBJECT OF THE PRESENT INVENTION

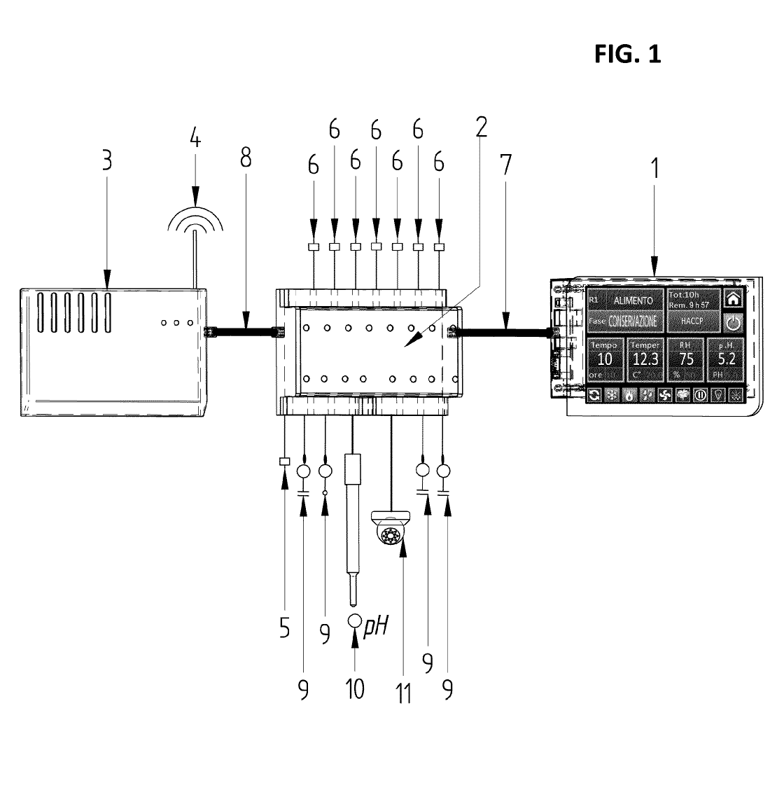

With reference to FIG. 1, the device for the control and management of the conserving and/or processing of foods, in a closed mobile or fixed space, comprises a user interface with controls and data entry (1), a programmable master unit control integrated with a system of measure of pH (2) consisting, preferably but not exclusively by one or more PLC, containing a software program with memory, means for controlling the physical parameters of the space in which the food is inserted and/or said food (9) such as by way of non-limiting example “temperature—humidity—air speed—shaking of the food—etc”, means for controlling the continuous pH measurement of the food to be conserved and/or processed (10), and means controlled by the software program in order to vary the physical parameters of the space in which is inserted the food and/or said food, if pH is outside of a predetermined safety interval (6), such as by way of non-limiting example means for the variation of “temperature—air speed—shaking of the food—humidity, etc.”.

Data of the food that has to be conserved and/or processed are inserted through the elements of data entry by means of a user interface (1), said data will be stored in the “master unit”.

The software contained in “master unit” (2) stores the safety interval of pH that the food must maintain in every phase of conserving and/or processing and starts phases stored for conserving and/or processing and in each single phase, establishes and performs a determined trend of the physical parameters of the space in which the food is inserted and/or said food, such as air speed, shaking of the food, humidity and temperature.

The system of measurement of the pH is made to run continuously, and before coming into operation is calibrated and for greater security is calibrated at intervals of time.

The calibration of the measuring system of the pH integrated to the master unit (2), takes place immersing the probe for the control of pH measurement (10) in two solutions at known pH respectively 7 and 4 so that the software can acquire the potential difference produced by the probe for the control of pH measurement (10) at that given known value of the solution to known pH and will determine the correct calibration curve of pH from 0 to 14.

During each phase the pH of the food to be processed and/or conserved is measured continuously and if the measured pH is not within the safety range, the software intervenes on the means for controlling and modifying the physical parameters of the space in which the food is inserted and/or said food, varying the same parameters depending on the software installed in the “master unit”, so as to influence pH to remain within the predetermined safety range.

The software, at the end of each phase, if it detects that pH has been brought back within the predetermined safety, will store in the “master unit” (2) a report of the data of correct execution of the phase and will make it viewable to user interface (1) and if required it will be sent by means of the data transmission device (3) to recipient coded in memory.

If the software detects that pH in a phase has not been brought back within the predetermined safety range, anyhow will store into the “master unit” (2) a data report of non-compliance with the safety parameter of pH in that phase, it will be displayed on the user interface (1) giving to the user the choice to stop or continue the process of conserving and/or processing the food, and if required, will be sent by means of the data transfer device (3) to recipient coded in memory.

All data are traceable by means of physical memory inserted into the Master unit (2) and all data concerning the physical elements of the space and the food contained in a closed fixed or mobile space, detected continuously or at intervals of predetermined time in all processes of conserving and/or processing, the operations of calibration of the measuring system of the pH, the failure of the means of variation of the physical parameters of the closed space and/or of said food, the failure of the means of physical parameters control of the closed space and/or said food are transmitted by means of the data transmission device (3).

The system of measurement of pH is constituted by: a pH meter integrated into the “master unit” (2), one or more probes for the control of pH measurement (10) and a calibration software integrated into the “master unit” (2).

### DESCRIPTION OF THE LOGIC DIAGRAM OF THE DEVICE OBJECT OF THE PRESENT INVENTION

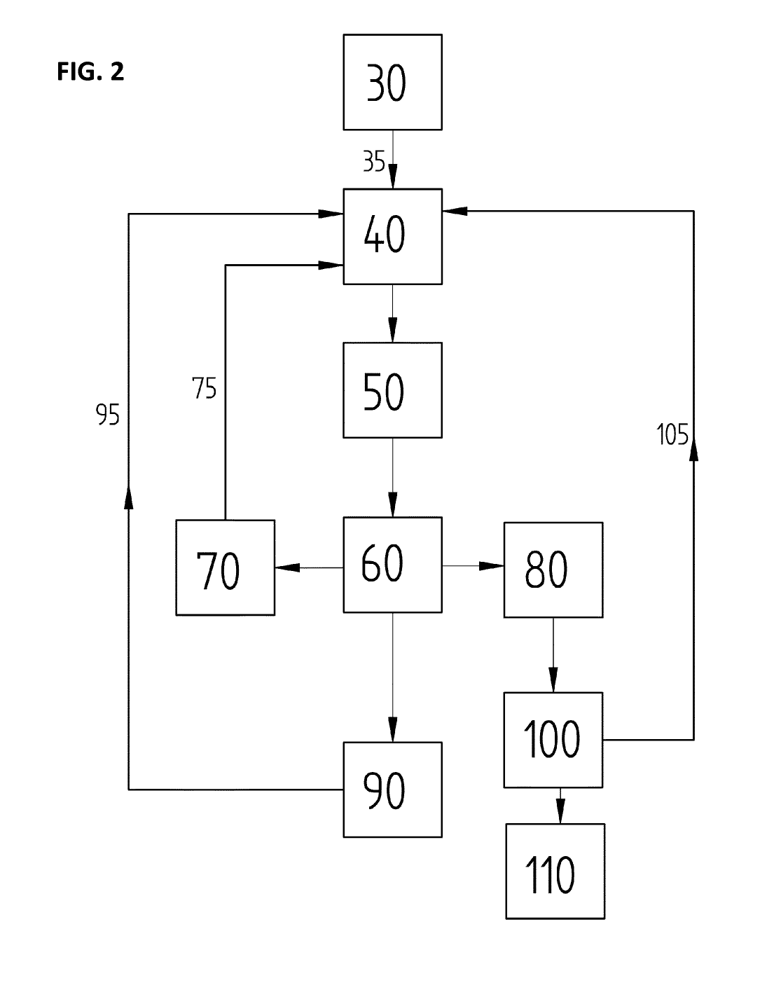

The method object of the present invention is schematically represented in FIG. 2, the method for conserving and/or processing of a food involves the following steps:

30 Entry of the food Data that you want to conserve and/or transform into a mobile or fixed closed space, data entry takes place via a real keyboard or touch screen or in any other way;

35 sending data to a master unit;

40 processing of data in a master unit, which contains a memory and a software program and that according to the entered data establishes the phases of conserving and/or processing, storing safety intervals of pH of the food which must be maintained in each phase;

50 continuous control during each phase of the physical parameters of the space and/or the food so that they are maintained in predefined intervals by the software;

60 continuous monitoring of pH in each phase;

70 verification, if controlled pH value is outside the safety range predetermined by the software;

75 continuous sending of the measured pH value to the master unit, which through the software changes the values of the physical parameters of the space and/or food, to influence the pH of the food to remain in the predetermined safety range;

80 verifies that in the duration time of the individual phase the pH value has come back in the predetermined safety range of pH;

90 The calibration of the integrated measuring system of pH, takes place by immersing the control means of pH measurement in two solutions at known pH respectively 7 and 4.

95 sending of the values obtained with the two solutions at pH 7 and pH 4 that through the software the master unit determines the correct calibration curve of pH from 0 to 14.

100 storing a data report positive if the phase was conducted with pH within the expected safety limits and negative if the phase was conducted with pH outside the required safety range;

105 sending to the master unit a report of positive or negative data of single phase of conserving and/or processing, the master unit if the data report is positive verifies if there is a next phase and will start automatically, if the report is negative will give to the user the choice whether to block or to continue the process of conserving and/or processing the food.

110 End of the process if there are other steps to be performed.

### DESCRIPTION OF AN EMBODIMENT OF THE PRESENT INVENTION APPLIED TO A STEWING—DRYING—AGING—SEASONING PLANT

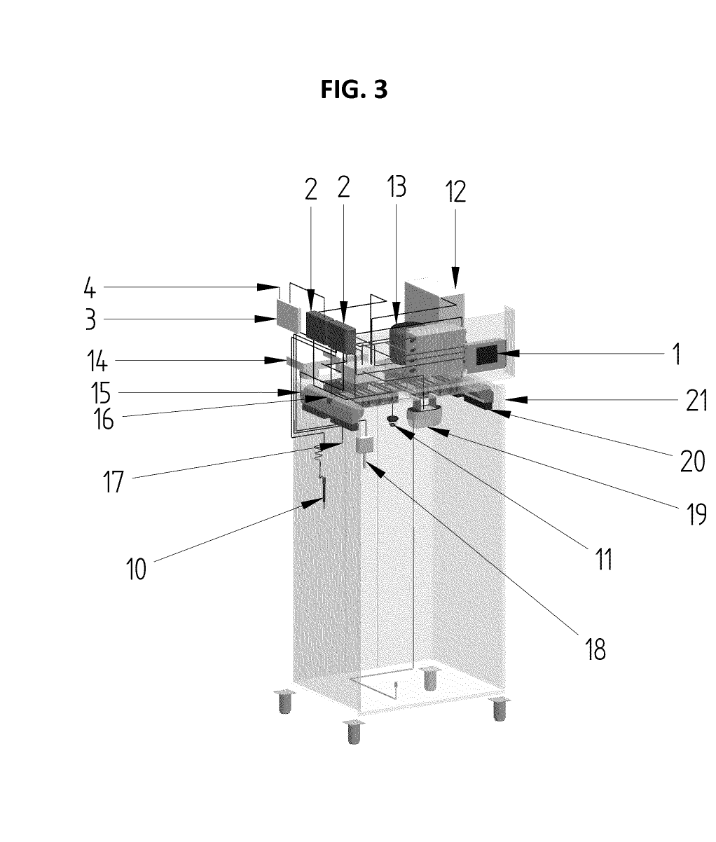

With reference to FIG. 3, the device for the control and management of the storage and/or processing of foods in a closed space, applied to a stewing—drying—aging—seasoning plant, comprises an interface with data insertion element (1), a control master unit programmable and integrated with a measuring system of pH, consisting of two PLC containing a memory, a software program (2), means for the control of physical parameters such as by way of non-limiting example “means to controlling the speed of the air (15), means for controlling humidity of the air (18), means for controlling the temperature of the air (17), means for controlling the pH measurement in continuous, to insert in the food to be conserved and/or processed (10), and means controlled by the software program in order to vary the physical parameters if the pH is outside of a predetermined safety interval, such means for the variation of the physical parameters are means for the variation in humidity of the air (12), means for varying the speed of the air (16), means for the variation of the physical parameter of the air of the closed space in which is inserted the food, heating unit (20) and refrigeration unit (13). Through data input elements in the memory of master unit (2) food data you want to conserve and/or process are entered through the user interface (1) , for example: “time—temperature—humidity—pH safety range,” The software stores the content in the PLC and determines the course of the physical parameters inside the closed space to influence the pH of the food to remain in the range of pH that food safety must be maintained in every phase of conservation and/or processing.

The software initiates the phase of conserving and/or processing of a foodstuff and for each phase establishes and performs a certain trend of physical parameters, such as speed, humidity and the temperature of the closed space in which the food is inserted. During each phase pH (10) of the food to be processed is continuously measured. If measured pH is not within the safety range of pH during conserving and/or processing that is executing the PLC intervenes on the means for the control and the variation of the physical parameters of the air, for example on means for controlling the speed of the air (15), on the means for the control and the variation of air humidity (18,12), on the means for the control and the variation of the temperature (17,20,23), varying depending on the software installed in the master PLC (2) the speed, the humidity and the air temperature inside the closed space in which the food is inserted so as to bring pH within the predetermined safety range.

If the software detects that the pH of food safety has been brought back within the predetermined interval, at the end of each phase, the unit will store in the “master unit” (2) a data report of correct execution of the phase and will make it viewable on the user interface (1) and if required will be sent by means of the data transmission device (3) to recipients coded in memory.

If the software detects that the pH in a phase has not been brought back within the predetermined pH safety range, in any case a data report of non-compliance with the safety parameter of the pH in that phase will be stored into the “master unit” (2), it will be displayed on the user interface (1) giving to the user the choice to stop or continue the process of conserving and/or processing of the food, and if required, will be sent by means of the data transfer device (3) to recipient coded in memory.

For the safety of the analysis and control system of the pH of the food, the calibration of the measuring system of the pH integrated to the master unit (2), takes place by immersing the means of control of the pH measurement (17) in two solutions at known pH respectively at pH 7 and 4 so that the software can acquire the potential difference produced by the probe to measure the pH (17) at that given the known value of the solution with the known pH and will determine the correct calibration of the curve of pH from 0 to 14.

### DESCRIPTION OF THE GRAPH AND THE TABULATED CREATED AND STORED BY THE DEVICE OBJECT OF THE PRESENT INVENTION

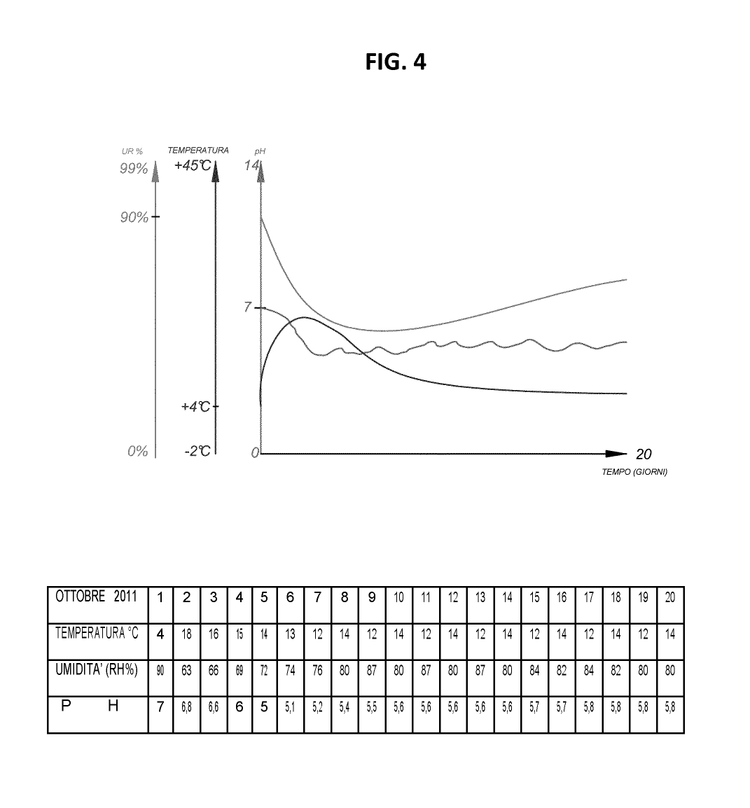

Non-limiting example of chart and printout produced by the software with reference to FIG. 4, with data acquired in the memory on Board of the “Master unit” (2) in 20 days, which if required will be sent automatically by means of the data transmission device (3) to recipient coded in memory or to a data bank. The same data through a serial connection present in the “Master unit” (2) can be downloaded to a computer for analysis and printing.

The examples given are for illustrative purposes and possible variants within reach of a person skilled in the art are possible.

1. Device for controlling, analyzing and managing phases of conservation and/or processing of food in a mobile or fixed closed space comprising a user interface with elements for data entry (1), a master control unit with memory and software (2), a management means system of the physical parameters of the food and/or of the space in which said food 6) is inserted, integrated means for controlling and measuring the pH, means for controlling physical parameters of food and/or of the space in which said food (6) is inserted, characterized by the fact that the master unit has a software program which has in memory one or more foods to be conserved and/or transformed, and for each food the succession of variations of the Physical parameters for each phase of conserving and/or processing, which has for each phase a safety interval of pH where said software manages for each value of the pH measured outside the safety interval of each phase a management program of physical parameters of food and/or the space in which said food (6) is inserted to bring the pH value within the safety interval of pH, that said integrated means for controlling and measuring the pH is provided with a calibration system of the means for controlling and measuring the pH (10).

2. Device for controlling, analyzing and managing phases of conservation and/or processing of food in a mobile or fixed closed space according to claim 1 characterized in that the measuring system of the pH that has a pH integrated calibration system for controlling and measuring the pH (10) is equipped with one or more probes for pH, two solutions with known pH and a software that before and/or during each phase calibrates one or more probes for pH through sequential immersion of said probe/s in the two solutions at known pH, tracing the curve of pH from 0 to 14, parameterizing and recoding the integrated pH-metric software system.

3. Device for controlling, analyzing and managing phases of conservation and/or processing of food in a mobile or fixed closed space according to claim 1 characterized in that the means for controlling physical parameters of the food and/or of the space in which said food (6) is inserted, are one or more temperature probes, one or more humidity probes, one or more probes to controlling the air velocity and/or shaking of the food.

4. Device for controlling, analyzing and managing phases of conservation and/or processing of food in a mobile or fixed closed space according to claim 1 characterized by the fact that all data regarding the physical elements of the space and the food inserted in a fixed or mobile closed space, are detected continuously or at predetermined and programmable time intervals, in all conserving and/or processing processes, all the calibration operations of the measuring system of the pH, all the failures of the variation means of physical parameters of the closed space and/or said food, all the failures of the control means of physical parameters of the closed space and/or said food are stored in the master unit.

5. Method for controlling, analyzing and managing phases of conservation and/or processing of food in a mobile or fixed closed space, comprising inserting, in a software program integrated into a master unit, the data of the food or foods, physical parameters of the closed space and/or said food, phases of conserving and/or processing that the food and/or the space in which said food is inserted must follow characterized in that said software program integrated into the master unit stores a safety interval of the pH of the food that must be maintained in each phase of conserving and/or processing set by the user, which manages, in each phase, for each value of the measured pH which falls outside the safety interval of each phase a management program of the physical parameters of the food and/or the space in which said food is inserted (6) that brings back the pH value within the safety interval of the pH, that calibrates the measurement system of the pH.

6. Method for controlling, analyzing and managing phases of conservation and/or processing of food in a mobile or fixed closed space, according to claim 5 characterized in that the calibration of the system for continuous measurement of pH in a food is made through the calibration of the probes in two solutions at known pH and through a software integrated to the system which traces the curve of pH from 0 to 14.

7. Method for controlling, analyzing and managing phases of conservation and/or processing of food in a mobile or fixed closed space, according to claim 5 characterized in that at the end of each phase a series of data is stored inside the device, said series of data are positive if the phase was carried out with the pH in the safety limits and negative if the phase was conducted with the pH outside the safety limits of the selected interval.

8. Method for controlling, analyzing and managing phases of conservation and/or processing of food in a mobile or fixed closed space, according to claim 6 characterized in that the measured pH value is continuously monitored and/or transmitted by a device of data transmission (3) to one or more recipients coded in said device.

9. Method for controlling, analyzing and managing phases of conservation and/or processing of food in a mobile or fixed closed space, according to claim 7 characterized in that the master unit at the end of each phase of conserving and/or processing, gets a set of values, if these values are all inside the set safety interval, automatically the next phase starts, and if these values fall outside the safety interval, the device before starting the next phase will communicate and store a report of the values, and wait for instructions from the user whether to continue the process of conserving and/or processing or stop it.

10. Method for controlling, analyzing and managing phases of conservation and/or processing of food in a mobile or fixed closed space, according to claim 6 characterized in that the measuring system of the pH in a food is integrated to the device object of the present invention, and that the calibration takes place by immersing the means of control of the pH measurement (10) in two solutions at known pH respectively at pH 7 and 4 so that the software can acquire the difference of the potential produced by the measuring probe of pH (10) at that given known value of the solution with known pH by determining the correct calibration of the curve of pH from 0 to 14 in the measuring integrated system of pH.
